(19) United States
(12) Patent Application Publication
(10) Pub. No.: US 2003/0047669 A1
(43) Pub. Date: Mar. 13, 2003

(54) Light sensor apparatus

(75) Inventor: Takahisa Hirano, Tagata-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tac Kabushiki Kaisha, Tokyo (JP)

(21) Appl. No.: 09/951,878

(22) Filed: Sep. 13, 2001

(51) Int. Cl. H01J 40/14

(52) U.S. Cl. 250/214 R

(57) ABSTRACT

The light sensor apparatus uses a light-emitting element which irradiates light on a detection area and a light-receiving element which receives light from the detection area. The light-receiving element sets the threshold level to an intermediate level between an output level when a detection target object exists within the detection area and an output level when the detection target object does not exist within the detection area. As a result of this, the threshold level is constantly set to a level in compliance with the detection target object such as a paper, a mark, or the like.

### BACKGROUND OF THE INVENTION

1. Field of the Invention

The present invention relates to an optical sensor apparatus having a threshold level setting function to set a threshold level when presence or absence of a paper or a mark or so.

2. Description of the Related Art

For example, an optical sensor apparatus of reflection type has a light-emitting element and a light-receiving element, irradiates light on a detection area from the light-emitting element, and receives reflection light from the detection area by the light-receiving element. The reflection light from the detection area is weak when a conveyed paper does not exist in the detection area. At this time, the output level of the light-receiving element is low. Also, the reflection light from the detection area is high when a conveyed paper exists within the detection area because the light is reflected on the paper. At this time, the output level of the light-receiving element is high.

Hence, whether or not a paper exists within the detection area can be detected by determining the output level of the light-receiving element.

In this case, the determination about the output level of the light-receiving element is realized by a circuit as follows.

That is, as shown in FIG. 9, a serial circuit comprising a light-receiving element 1 and a resistor 2 is connected between a terminal of +5 V and a ground, and a serial circuit comprising a semi-fixed resistor 3 and a resistor 4 is connected between a terminal of +5 V and a ground. The light-receiving element 1 has a characteristic that the internal resistance value decreases depending on the light-receiving amount.

A connection point between the light-receiving element 1 and the resistor 2 is connected to a plus input terminal of a comparator 5, and a connection point between the semi-fixed resistor 3 and the resistor 4 is connected to a minus input terminal of the comparator 5.

The semi-fixed resistor 3 determines the input level of the comparator 5 to the minus input terminal. This input level is the threshold level of the comparator 5. Once the input level is operated and set, the resistance value of the semi-fixed resistor 3 is fixed. Thereafter, it is not operated to change the resistance value before re-adjustment is required.

The internal resistance value of the light-receiving element 1 is large when the amount of received light is small. At this time, the voltage generated at the connection point between the light-receiving element 1 and the resistor 2 is lower than the voltage generated at the connection point between the semi-fixed resistor 3 and the resistor 4. Further, the output level of the comparator 5 goes to the low level.

Also, the internal resistance value of the light-receiving element 1 is small when the amount of received light is large. At this time, the voltage generated at the connection point between the light-receiving element 1 and the resistor 2 is higher than the voltage generated at the connection point between the semi-fixed resistor 3 and the resistor 4. Further, the output level of the comparator 5 goes to the high level.

Therefore, when the light-receiving element 1 detects a paper, the output level of the comparator 5 changes to the high level from the low level.

The light sensor apparatus having a structure described above can be used to detect, for example, a black mark printed on a paper. That is, light reflection is reduced above the mark, and the output level of the comparator 5 then turns to the low level.

In addition, light reflection increases above the part of the paper other than the mark, so that the output level of the comparator 5 then turns to the high level.

Accordingly, mark detection can be enabled by the output level of the comparator 5.

If the paper where the mark is printed is white, the voltage level inputted to the plus input terminal of the comparator 5 has a great difference between when a mark is detected and when a non-mark part is detected. In this case, mark detection is enabled.

However, in case where the paper is blown, the voltage level inputted to the plus input terminal of the comparator 5 becomes low when a non-mark part is detected. In addition, when the color of a mark has become light, the voltage level inputted to the plus input terminal of the comparator 5 is high at the time of mark detection.

Thus, even when the voltage level inputted to the plus input terminal of the comparator 5 changes, the threshold level of the comparator 5 is set by the semi-fixed resistor 3 and is therefore not changed.

Therefore, the light sensor apparatus having a structure as described above involves a situation that the voltage level inputted to the plus input terminal of the comparator 5 becomes lower than the threshold level when a non-mark part is detected or that the voltage level inputted to the plus input terminal of the comparator 5 becomes higher than the threshold level when a mark is detected.

That is, the light sensor apparatus having a structure as described above involves operation errors, e.g., the output level of the comparator 5 can go to the low level to show a mark-detected state when a non-mark part is detected, or the output level of the comparator 5 can go to the high level to show a non-mark-detected state when a mark is detected.

Hence, there are needs for a light sensor apparatus capable of setting constantly a threshold level matched with a detection target object such as a paper, a mark, or the like.

### BRIEF SUMMARY OF THE INVENTION

A light sensor apparatus according to the present invention uses a light-emitting element which irradiates light on a detection area and a light-receiving element which receives light from the detection area. The light-receiving element sets the threshold level to an intermediate level between an output level when a detection target object exists within the detection area and an output level when the detection target object does not exist within the detection area.

### BRIEF DESCRIPTION OF THE SEVERAL VIEWS OF THE DRAWING

The accompanying drawings, which are incorporated in and comprise a part of the specification, illustrate presently embodiments of the invention, and together with the general description given above and the detailed description of the embodiments given below, serve to explain the principles of the invention.

FIG. 1 is a block diagram showing a hardware structure according to an embodiment;

FIG. 2A and FIG. 2B are flowcharts showing threshold level setting processing;

FIG. 3 is a flowchart showing threshold level setting processing according to another embodiment;

FIG. 4 is a flowchart showing threshold level setting processing according to another embodiment;

FIG. 5 is a view showing a table and a time counter according to another embodiment;

FIG. 6 is a flowchart showing time-count processing by the time counter;

FIG. 7 is a flowchart showing threshold level change processing;

FIG. 8 is a flowchart showing the process at the time of turning on the power source, according to another embodiment; and

FIG. 9 is a circuit structure diagram showing a prior art example.

### DETAILED DESCRIPTION OF THE INVENTION

In the following, explanation will be made of a light sensor apparatus according to an embodiment of the present invention.

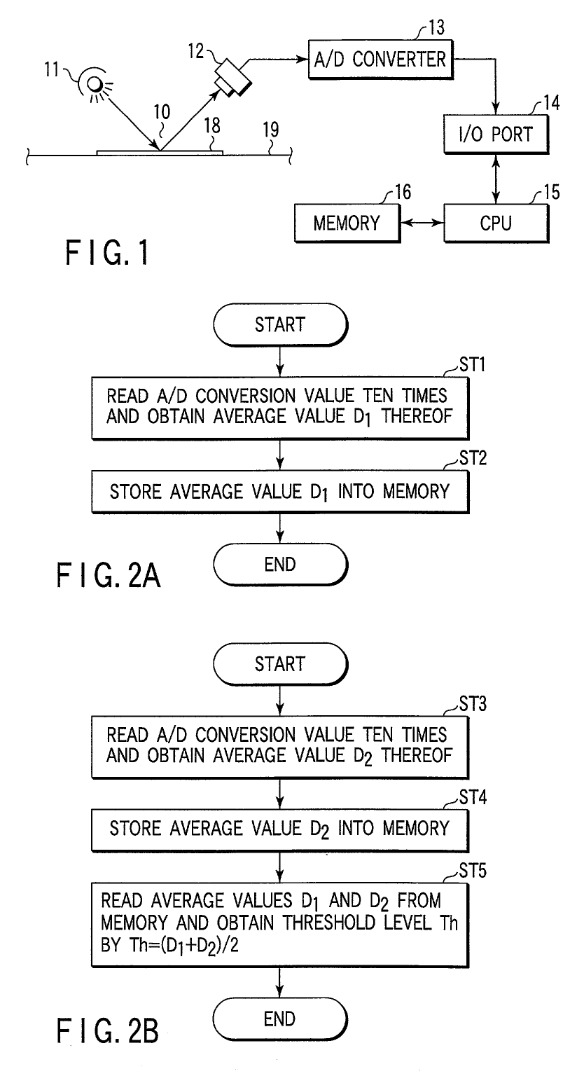

As shown in FIG. 1, a light sensor of reflection type is used. The reflection type light sensor is provided with a light-emitting element 11 which irradiates light to a detection area 10 obliquely from its upper side, and a light-receiving element 12 which receives reflection light from the detection area 10.

The light sensor inputs the output of the light-receiving element 12 to an A/D (analogue/digital) converter 13. The A/D converter 13 converts the output level of the light-receiving element 12 into digital data of 0 to 255 gradation levels, and inputs this digital data to an I/O port 14.

The I/O port 14 is connected to a CPU (Central Processing Unit) 15. The CPU 15 is connected with a memory 16. The memory 16 comprises a ROM (Read Only Memory), a RAM (Random Access Memory), a flash memory, and the like.

The detection area 10 is formed on a convey route 19 for a paper 18. The convey route 19 may be of a type which conveys a paper with use of a belt conveyor or another convey type.

Explained next will be the setting of the threshold level. The setting of the threshold level will be explained with respect to a case where a mark on a paper 18 is taken as a detection target object.

The paper 18 is set on the convey route 19 such that the mark on the paper 18 is positioned within the detection area 10.

In this state, the CPU 15 performs the processing shown in FIG. 2A.

At first, an A/D conversion value as digital data from the A/D converter 13 is read ten times at a predetermined time interval. Further, an average value D₁ thereof is obtained (step ST1).

Subsequently, the obtained average value D₁ is stored into the RAM of the memory 16 (step ST2).

Next, the paper 18 is set on the convey route 19 such that the non-mark part on the paper 18 is positioned at the detection area 10.

In this state, the CPU 15 performs the process shown in FIG. 2B.

At first, an A/D conversion value as digital data from the A/D converter 13 is read ten times at a predetermined time interval. Further, an average value D₂ thereof is obtained (step ST3).

Subsequently, the obtained average value D₂ is stored into the RAM of the memory 16 (step ST4).

Furthers the average values D₁ and D₂ are finally read from the memory 16, and a threshold level Th is obtained from an equation of Th=(D₁+D₂)/2 (step ST5).

That is, the threshold level Th is set to an intermediate value between the average values D₁ and D₂, and this threshold level Th is stored into the flash memory of the memory 16.

Thus, this light sensor apparatus sets a mark on the paper 18 on which mark detection is actually carried out, at the detection area 10, to obtain the average value D₁ of the A/D conversion value. Also, the apparatus sets a non-mark part at the detection area 10, to obtain the average value D₂ of the A/D conversion value. Further, an intermediate value between the average values D₁ and D₂ is set as the threshold level Th.

Accordingly, this light sensor apparatus can set a threshold level optimal for the color of the paper 18 or the concentration of the mark, so that a mark printed on the paper can be carried out securely.

Next, a light sensor apparatus according to another embodiment of the present invention will be explained with reference to the drawings.

The hardware structure of this embodiment is the same as that shown in FIG. 1.

The threshold level detection in this case will be described with respect to the case that the paper 18 itself is a detection target object.

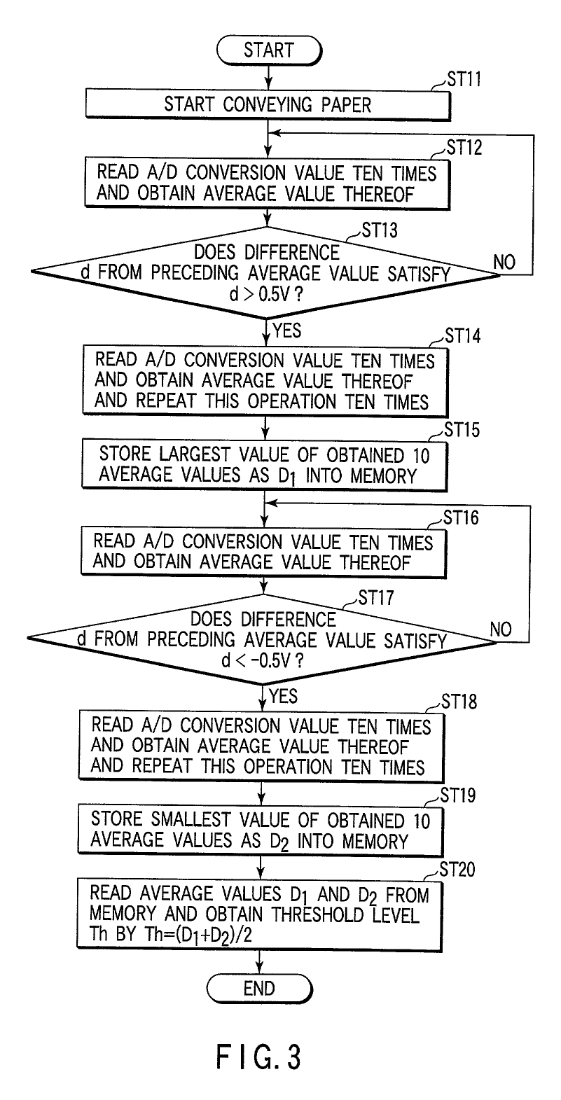

The CPU 15 executes processing shown in FIG. 3.

At first, the convey route 19 is driven to convey a paper 18 toward the detection area 10 (step ST11).

Further, an A/D conversion value from the A/D converter 13 is read ten times at a predetermined time interval. Further, the average value thereof is obtained (step ST12).

If the convey system of the convey route 19 is a belt conveyor system, the detection area 10 is above the belt conveyor, and the light-receiving element 12 receives reflection light from the belt conveyor.

That is, the light-receiving element 12 receives reflection light form the belt conveyor if the paper 18 does not yet reach the detection area, so that the output level of the light-receiving element 12 is low. Also, if the paper 18 has reached the detection area 10, reflection light from the paper 18 is received, so that the output light of light-receiving element 12 is high.

Accordingly, it is possible to determine whether or not the paper 18 reaches the detection area 10, by obtaining a difference d between the average value obtained when the A/D conversion value is read ten times when the paper 18 does not yet reach the detection area 10, and the average value obtained when the A/D conversion value is read ten times when the paper 18 reaches the detection area 10.

In this case, a reference for the difference between the average values to determine whether or not the paper 18 reaches the detection area 10 is set to 0.5 V. This reference voltage 0.5 V is determined from the relationship among the light-receiving-to-output characteristic of light-receiving element 12, color and material of the belt conveyor, type of the used paper 18. Further, the A/D conversion value from the A/D converter 13 is normally sufficiently smaller than 0.5 V while the light-receiving element 12 receives reflection light from the belt conveyor. In addition, while the light-receiving element 12 receives reflection light from the paper 18, the A/D conversion value from the A/D converter 13 is sufficiently larger than 0.5 V. By this setting, presence or absence of the paper 18 at the detection area 10 can be detected securely.

After obtaining an average, subsequently, the average value presently obtained is compared with an average value obtained at a preceding time, to determine whether or not the difference d exceeds 0.5 V (step ST13).

At the time of shipping, there is not average value obtained at a preceding time. Therefore, a false numerical value appropriate for the hardware used is stored in a memory, and this false value is used as an average value which obtained at a previous time.

Further, if the difference d satisfies d≦0.5 V, the paper 18 is determined as not having reached the detection area 10, and the processing returns to the step ST12, to obtain an average value again.

Alternatively, if the difference d satisfies d>0.5 V, the paper 18 is determined as having reached the detection area 10, and the A/D conversion value from the A/D converter 13 is read ten times at a predetermined time interval. Further, an average value thereof is obtained. This operation is repeated ten times (step ST14).

Subsequently, of the ten average values obtained in the step ST14, the largest value is stored as an average value D₁ into the RAM of the memory 16 (step ST15).

Subsequently, the A/D conversion value as digital data from the A/D converter 13 is read ten times at a predetermined time interval. Further, the average value thereof is obtained (step ST16).

Next, the average value obtained in this time and the average value obtained in a preceding time are compared with each other, to determine whether or not the difference d is greater in the minus direction than −0.5 (step ST17).

This determines whether or not the paper 18 has left the detection area 10.

If d≦−0.5, it is determined that the paper 18 has not yet left the detection area 10. In this case, the process returns to step ST16, in which the average of the digital data items is obtained.

If d<−0.5, it is determined that the paper 18 has already left the detection area 10. Then, the A/D conversion value is read ten times from the A/D converter 13 at prescribed intervals and the average of the ten values is acquired. The reading the value ten times and the acquisition of the average are repeated ten times (step ST18).

Subsequently, of ten average values obtained in the step ST18, the largest value is stored as an average value D₂ into the RAM of the memory 16 (step ST19).

Further, at last, the average values D₁ and D₂ are read from the memory 16, and the threshold level Th is obtained by an equation of Th=(D₁+D₂)/2 (step ST20).

That is, the threshold level Th is set as an intermediate value between the average values D₁ and D₂, and this threshold level Th is stored into the flash memory of the memory 16.

Thus, in this light sensor apparatus, a paper 18 is actually conveyed to obtain an average value D₁ of A/D conversion values when the paper is existing in the detection area 10, and an average value D₂ of A/D conversion values is obtained when the paper leaves the detection area 10. Further, an intermediate value between the average values D₁ and D₂ is set as a threshold level Th.

Therefore, this light sensor apparatus can set a proper threshold level in compliance with the color situation of the paper 18, so that the paper 18 being conveyed on the convey route 19 can be securely detected.

Meanwhile, if the light sensor is continuously used, the output characteristic of the light-receiving element 12 changes due to deterioration with age. That is, the output level of the light-receiving element 12 shifts.

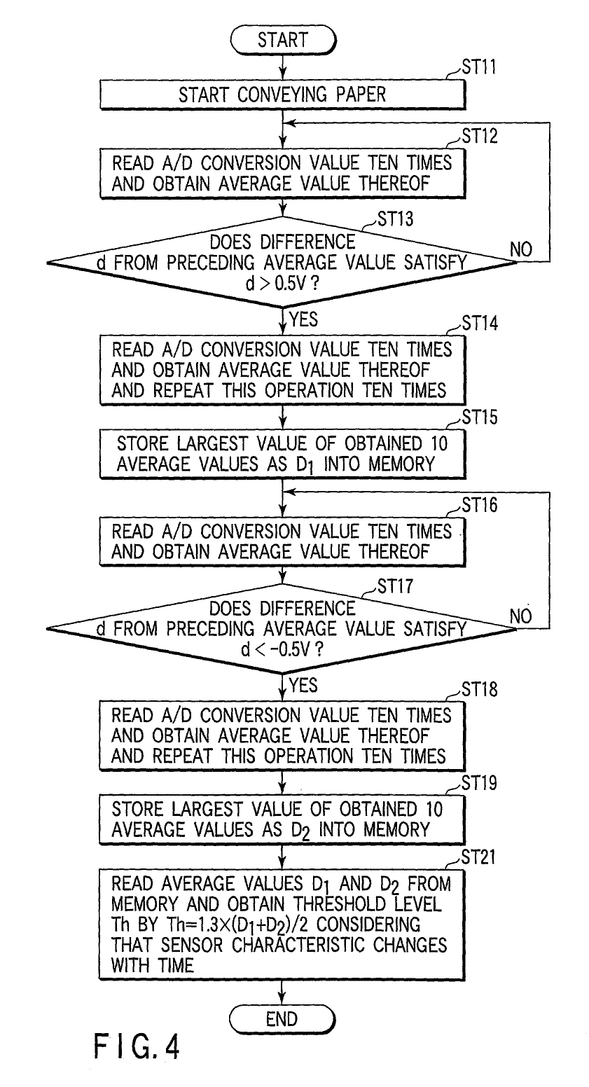

For example, if the light sensor is used for 50,000 hours, the output level of the light-receiving element 12 is expected to shift 1.3 times. At this time, in place of the processing at the step ST20 in the flowchart shown in FIG. 3, the processing at the step ST21 is carried out, as shown in FIG. 4.

Note that the processing from the step ST11 to the step ST19 is the same as the processing described in FIG. 3.

That is, in the step ST19, the average value D2 is stored into the RAM of the memory 16, and subsequently, the average values D₁ and D₂ are read from the memory 16, to obtain the threshold level Th by an equation of Th=1.3×(D₁+D₂)/2 (step ST21).

The light sensor may undergo aging, raising the output level of the light-receiving element 12. Nonetheless, the aging of the light sensor can be compensated for, because the threshold level Th increased in proportion to the output level of the element 12.

In the above, the threshold level is set predicting that the output level of the light-receiving element 12 shifts as the light sensor is used for a long time, the threshold level may be changed in accordance with elapse of time.

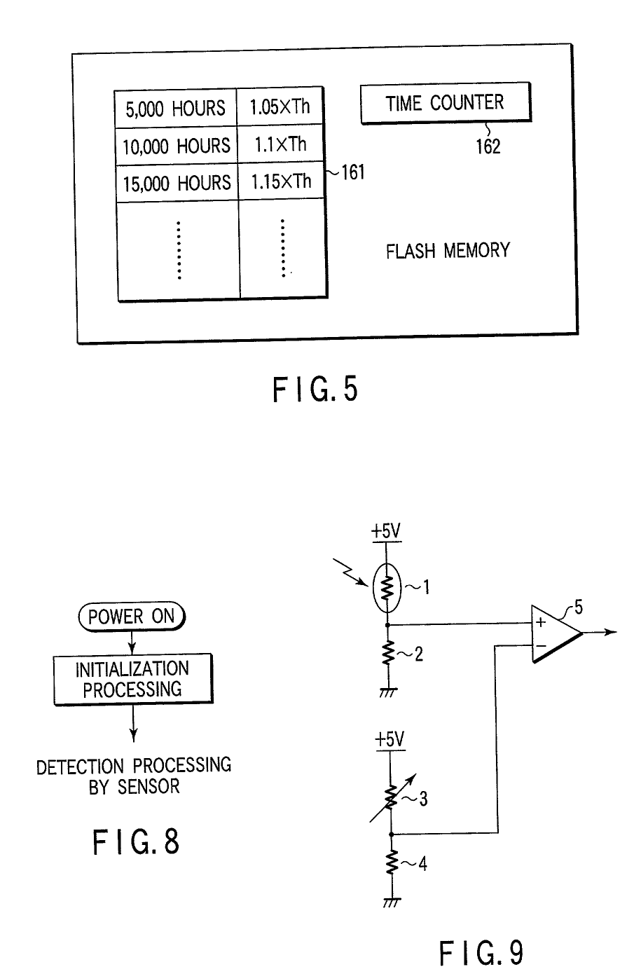

That is, a table 161 and a time counter 162 are stored in the stored in the flash memory (i.e., memory 16). The threshold level Th is increased step by step in accordance with the table. More precisely, as shown in FIG. 5, the level Th may be first increased 1.05 times upon lapse of 5,000 hours, then increased 1.1 times upon lapse of 10,000 hours thereafter, further increased 1.15 times upon lapse of 15,000 hours, and so forth.

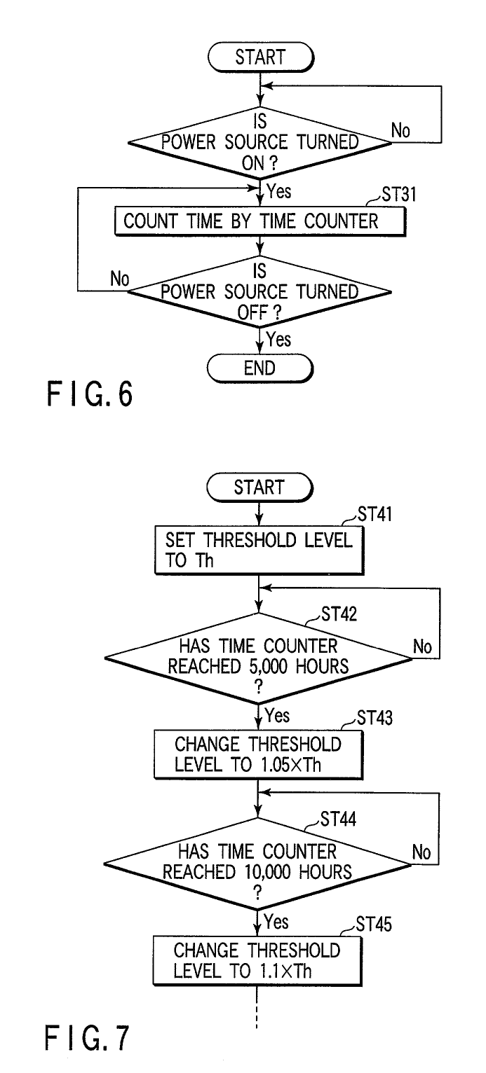

The CPU 15 lets the time counter 162 count time while the power source is ON, as shown in FIG. 6 (step ST31).

Also, as shown in FIG. 7, the CPU 15 firstly obtains the threshold level Th by the processing shown in the step ST20 in FIG. 3 and the step ST5 in FIG. 2B, and sets it in the flash memory of the memory 16 (step ST41).

Subsequently, it stands by until the time counter 162 counts 5,000 hours (step ST42).

When the time counter 162 counts 5,000 hours, the threshold level Th currently set is changed to 1.05×Th, based on the data in the table 161 (step ST43).

Thus, aging is compensated for by multiplying the threshold level by 1.05 at the time point when the light sensor is used for 5,000 hours. Subsequently, it stands by until the time counter 162 counts 10,000 hours (step ST44).

When the time counter 162 counts 10,000 hours, the threshold level of 1.05×Th is changed to 1.1×Th, based on the data in the table 161 (step ST45).

Thus, at the time point when the light sensor is used for 10,000 hours, the threshold level is multiplied by 1.1 to respond to aging.

Thereafter, the threshold level is changed based on the data in the table 161, every time 5,000 hours are elapsed.

Even in this operation, it is possible to respond sufficiently to aging of the light sensor.

Alternatively, in place of using the table, the threshold level Th can be set in accordance with aging of the light sensor. For example, as shown in FIG. 8, initialization processing is carried out whenever the power source is turned on. Therefore, the threshold level is reset in this initialization processing.

The setting of the threshold level at this time may be carried out by the processing shown in FIG. 3. Threshold level setting for mark detection can be carried out by the processing shown in FIGS. 2A and 2B.

In this manner, it is possible to respond rapidly to aging of the light sensor.

Although description has been made above in the case of resetting the threshold level in the initialization processing at the time of turning on the power source, the present invention is not limited to this case. The structure may be arranged such that a user can arbitrarily reset the threshold level at a time of using the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light sensor apparatus comprising:
a light sensor having a light-emitting element which irradiates light on a detection area, and a light-receiving element which receives the reflection light from the detection area; and
setting means which sets, as a threshold level, an intermediate level between an output level of the light-receiving element when a detection target object exists within the detection area and an output level of the light-receiving element when the detection target object does not exists within the detection area.

2. The apparatus according to claim 1, wherein the setting means changes the set threshold level, considering that a characteristic of the light sensor changes with use time.

3. The apparatus according to claim 1, wherein the setting means comprises a time counter and a table having a threshold level which is changed as time passes, a threshold level corresponding to an elapse of time detected by the time counter is read, and the threshold level set is changed.

4. The apparatus according to claim 1, wherein the setting means detects an output level of a light-receiving element when the detection target object exists within the detection area at a time of turning on a power source, and an output level of the light-receiving element when the detection target object does not exists within the detection area, to reset the threshold level.

5. A light sensor apparatus comprising:
a light sensor having a light-emitting element which irradiates light on a detection area, and a light-receiving element which receives the reflection light from the detection area;
determination means which takes in an output level of the light-receiving element a plurality of times and determines whether or not a difference exceeding a preset predetermined level exists between preceding and following ones of the plurality of output levels taken in; and
setting means which sets, as a threshold level, an intermediate level between the preceding and following ones of the output levels, if the determination means determines the difference exceeding the predetermined level.

6. The apparatus according to claim 5, wherein the setting means changes the set threshold level, considering that a characteristic of the light sensor changes with use time.

7. The apparatus according to claim 5, wherein the setting means comprises a time counter and a table having a threshold level which is changed as time passes, a threshold level corresponding to an elapse of time detected by the time counter is read, and the threshold level set is changed.

8. The apparatus according to claim 5, wherein the determination means takes in an output level of the light-receiving element a plurality of times at a time of turning on a power source, and determines whether or not a difference exceeding a preset predetermined level exists between preceding and following ones of the plurality of output levels taken in, and
the setting means sets, as a threshold level, an intermediate level between preceding and following ones of the output levels, if the determination means determines the difference exceeding the predetermined level at the time of turning on the power source.

9. The apparatus according to claim 5, wherein the determination means reads the output level of the light-receiving element a plurality of times to obtain average values thereof, and determines whether or not a difference exceeding a preset predetermined level exists between preceding and following ones of average output levels obtained.
